(19) United States
(12) Patent Application Publication
(10) Pub. No.: US 2007/0261445 A1
(43) Pub. Date: Nov. 15, 2007

(54) Thin-walled blown glass ornament that opens

(76) Inventor: Robert Mostowski, Czestochowa (PL)

Correspondence Address: SOFER & HAROUN LLP., 317 MADISON AVENUE, SUITE 910, NEW YORK, NY, 10017, US

(21) Appl. No.: 11/799,103

(22) Filed: Apr. 30, 2007

Related U.S. Application Data
(63) Continuation of application No. 11/009,960, filed on Dec. 10, 2004.

(30) Foreign Application Priority Data
Jun. 12, 2002 (PL) P.354439
Jul. 18, 2001 (PL) P.348796

(51) Int. Cl. C03B 33/00

(52) U.S. Cl. 65/56

(57) ABSTRACT

A method for making a decorative ornament includes mouth blowing a first thin-walled glass object and cutting the first mouth blown thin walled glass object into first and second modules. The first and second modules are dimensionally and spatially correlated, where the removal of the second module results in an a first module that forms the decorative ornament, the ornament having an opening therein corresponding to the removed second module.

### RELATED APPLICATIONS

This application is a Continuation of U.S. patent application Ser. No. 11/009,960, filed on Dec. 12, 2004, which is a National Phase application of PCT Patent Application No. PCT/PL02/00081, filed on Oct. 31, 2002, which in turn claims the benefit of priority from Polish Patent Application No. P. 354439, filed on Jun. 12, 2002,

This application also claims the benefit of priority from co-pending U.S. patent application Ser. No. 10/481,399, which is a National Phase Application No. PCT/PL01/00084, which in turn claims priority to Polish Patent Application No. P.348796, filed on Jul. 18, 2001.

All above listed priority applications are incorporated herein by reference.

### FIELD OF THE INVENTION

This invention relates to a thin-walled, blown glass, spatial body that opens to reveal an interior.

### BACKGROUND OF THE INVENTION

Various thin-walled, blown glass ornaments, in particular Christmas tree ornaments and other seasonal ornaments are presently in use.

All thin-walled, blown glass ornaments in use at present are characteristic in that they are comprised of a closed, spatial body of various shapes and typically contain one, sole opening for securing a suspension element to the body of the ornament. Among the known methods of manufacturing thin-walled, blown glass, Christmas ornaments there is a method described in the Polish Patent No. 171623 wherein a glass bulb is given an additional element of shape in the form of a projection vent situated on one of the longer walls of the bulb. This process takes place in the mould, while the bulb is being mouth blown. Once the bulb has been annealed, the projection vent is opened using a burner flame whereas the main fullering is sealed.

A method of manufacturing multi-element, thin-walled, blown glass, Christmas ornaments is known from European Patent No. 1028644, which describes a process wherein separate elements are assembled together by inserting a tenon, coated with quick setting adhesive, into a seat.

Among the methods of manufacturing thin-walled glass, blown glass, Christmas ornaments there is also a method known from the U.S. Pat. No. 4,491,494, which relates to the surface decoration of blown glass ornaments. This method involves the application of a heat shrinking film onto the surface of an ornament. As well, there is a method known from the German patent application no. 3916839 A1 in which a predetermined part of an ornament's surface is coated with an adhesive; the ornament is then dipped into a container of plastic micro-spheres. The micro-spheres used for covering the ornament are partially filled with a scent.

These and other Christmas tree ornaments as well as methods of manufacturing thereof give the possibility of obtaining only a limited range of thin-walled, blown glass ornaments.

### OBJECT AND SUMMARY OF THE INVENTION

With the foregoing in mind, it is the object of the present invention to provide a new range of Christmas tree ornaments and other seasonal ornaments made of thin-walled, blown glass characteristic in that: a) they can be repeatedly opened in order to reveal an interior, without causing any breakage; and b) additional elements can be placed inside the ornaments which determine the attractiveness of the features thereof.

The object of this invention is created by constructing a thin-walled, blown glass ornament that opens, in particular a Christmas tree ornament, comprised of any spatial body characteristic in that the body consists of one or two modules mouth blown in separate moulds or mouth blown without using the mould, the so-called top module and bottom module which are dimensionally and spatially correlated with each other in the connection plane thereof.

The top and bottom modules can be connected or disconnected (separated) by means of locks situated on the rim of each module. The modules are then brought together by means of an articulating hinge or other articulated joint installed in the connection plane, which enables frequent bending aside of both modules, as well as by means of at least one lock (clip-lock) situated on the rim of the connection plane of each module.

The top module, comprised of one spatial element of shell construction, may be arranged or connected with the bottom module so as to constitute one whole; or, the modules may be disconnected (opened) so as to reveal an interior.

The upper unit may also consist of two or more spatial elements composing the entire element of the top module; thus, each element of the top module is capable of bending aside while remaining in articulated connection with the bottom module. Such a method further requires that the separate elements of the top module be connected to each other.

The bottom module may consist of a shell or spatial construction with a hollow interior, which provides a larger capacity for enclosing separate, miniature, ornamental objects. Alternatively, the interior of the bottom module may be closed from the top of the connection plane such that the bottom module constitutes a closed, solid body. Additionally, the bottom module may feature a flat bottom, which allows it to be placed (as opposed to suspended from above) on a flat surface. In the case of a flat-bottomed module, the top module has a closed fullering.

At least one miniature ornamental object may be contained within the body of the ornament so as to constitute an ornament-within-an-ornament. The miniature ornamental object may be placed directly on the interior wall of the bottom and/or of the top module; it may also be fastened onto the flat surface, or the ‘roof’, covering the bottom module.

The entire surface of the ornament is covered with ornamental imprints obtained from a glass-blowing mould and is colorfully treated with such elements as paint, glitter, gold and/or patina and/or is engraved.

The solution, according to the invention, enables the generation of an entirely new, ‘family’ of ornaments made of thin-walled, blown glass on the basis of two, primary construction modules constituting a top and a bottom. The top and the bottom modules can be in articulated connection with each other and can also be disconnected (separated) in order to reveal a miniature, ornamental object, or other gifts placed inside.

### BRIEF DESCRIPTION OF THE DRAWINGS

The object of the invention is illustrated in the attached drawings in which:

FIG. 1 is a front view of a closed ornament with ornamental expressions on its surface;

FIG. 2 illustrates the same ornament opened by bending aside a one-piece top module and including a miniature ornamental object inside;

FIG. 3 illustrates an ornament opened by bending aside two parts of a two-piece top module; the bottom module of an ornament features a flat bottom, which allows an ornamental object to be placed on a flat surface;

FIG. 4 illustrates an ornament opened and separated after prior unfastening of locks installed on the outer surface;

FIG. 5 illustrates an ornament in a shape of Santa Claus with a closed bag on his back;

FIG. 5a illustrates an ornament in a shape of Santa Claus with an open bag on his back;

FIG. 6 illustrates a closed box with an ornamental object in a shape of a fiddler installed on the lid of a box;

FIG. 6a illustrates a half-open box with an ornamental object in a shape of a fiddler installed on the lid of a box;

FIG. 7 illustrates an ornament with a smooth outer surface, consisting of two hemispheres with hollow interiors and characteristic in that the hemispheres are connected by means of a joint which enables bending aside of the hemispheres; an ornament is closed and opened by means of a lock;

FIG. 7a illustrates an ornament from FIG. 7 opened so as to reveal an interior and suspended by means of a string;

### DETAILED DESCRIPTION

The object of this invention will become apparent from the following description and examples of the invention's illustrative features.

### EXAMPLE I

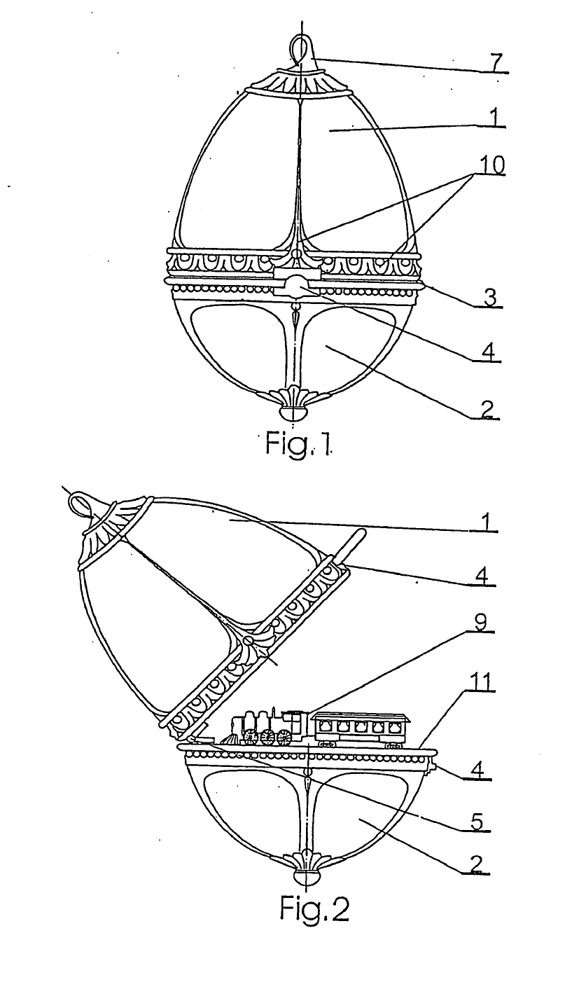

The ornament illustrated in FIG. 1 consists of two modules, top 1 and bottom 2, made in one mould or in separate moulds. The surface of both modules is covered with ornamental Imprints 10 obtained from a mould in which they have been mouth blown. Both modules 1 and 2 are connected in the connection plane 3 and both modules feature a two-piece clip-lock 4 enabling frequent opening and closing of the ornament. At the opposite side of the lock 4 there is a metal hinge 5 or an articulated joint (not shown), which enables opening of the ornament so as to reveal the interior. The interior of the ornament is hollow and thus can be freely filled with additional, miniature objects. The upper part of the top module 1 features a projection 7 functioning as a suspension means.

### EXAMPLE II

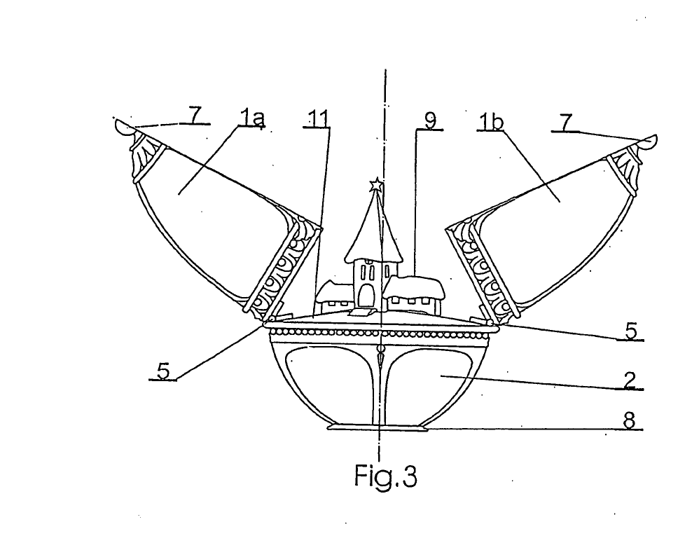

FIG. 2 illustrates an ornament, which has been opened (the top module is bent aside) with the help of a hinge 5 connecting the ornament's top module 1 with its bottom module 2 after prior opening of a two-piece clip-lock 4. Inside the ornament's connection plane 3 and on the bottom module 2 there is a flat surface 11 comprising a base upon which an additional, miniature, ornamental object 9 is installed. The ornament may be repeatedly opened and closed due to the articulated connection of both modules. A clip-lock 4 is installed on the outside of the ornament. The ornament may also be suspended by means of a loop 7.

### EXAMPLE III

FIG. 3 illustrates an ornament featuring a two-piece top module 1a and 1b. Each part of the two-piece top module is attached to an articulated joint 5. The upper part of each piece contains a projection 7 enabling suspension of the ornament by means of a lace, a lace hanger, an ornamental string, a bow or a wire. The bottom module 2 is provided with a flat base 8 which enables free placement of the ornament on any flat surface. The bottom module 2 can be a shell construction with a hollow interior or, alternatively, a closed solid body with a flat surface at the connection plane of both modules. In the case of a shell construction, a roof may be inserted onto the bottom module in order to provide a surface 11 upon which a miniature, interior ornament 9 may be placed. In case of a hollow interior, it can be filled with various objects which can be contained inside.

### EXAMPLE IV

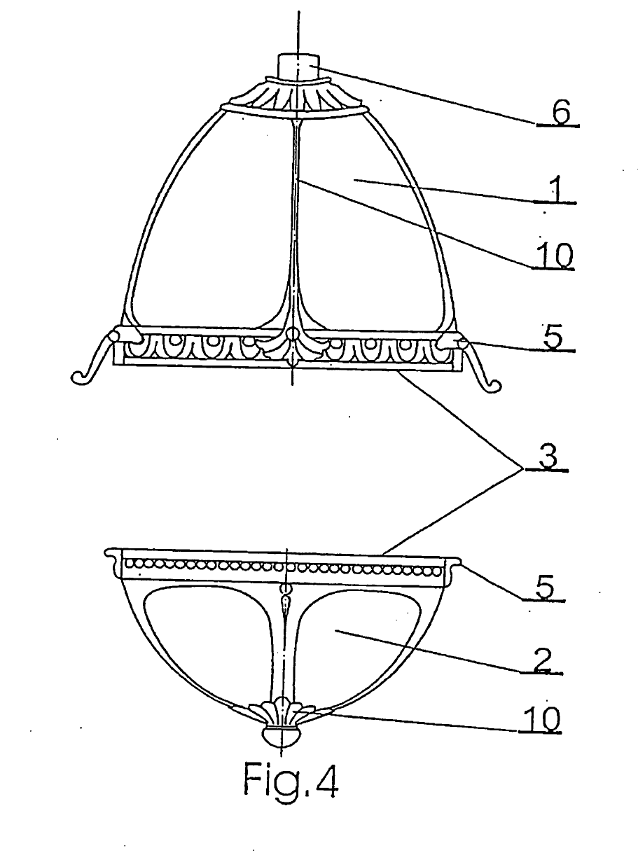

FIG. 4 illustrates an ornament made up of two modules, top 1 and bottom 9 separated permanently but which may also be re-connected by the opening and closing of clip-locks 5 situated on the rim of each module in the connection plane thereof. The upper part of the top module 1 features a closed fullering or a an open fullering for affixing a suspension means. The outer surface of both modules 1 and 2 is covered with the ornamental imprints 10. The interior of the ornament can be freely filled with various objects which can be contained inside.

### EXAMPLE V

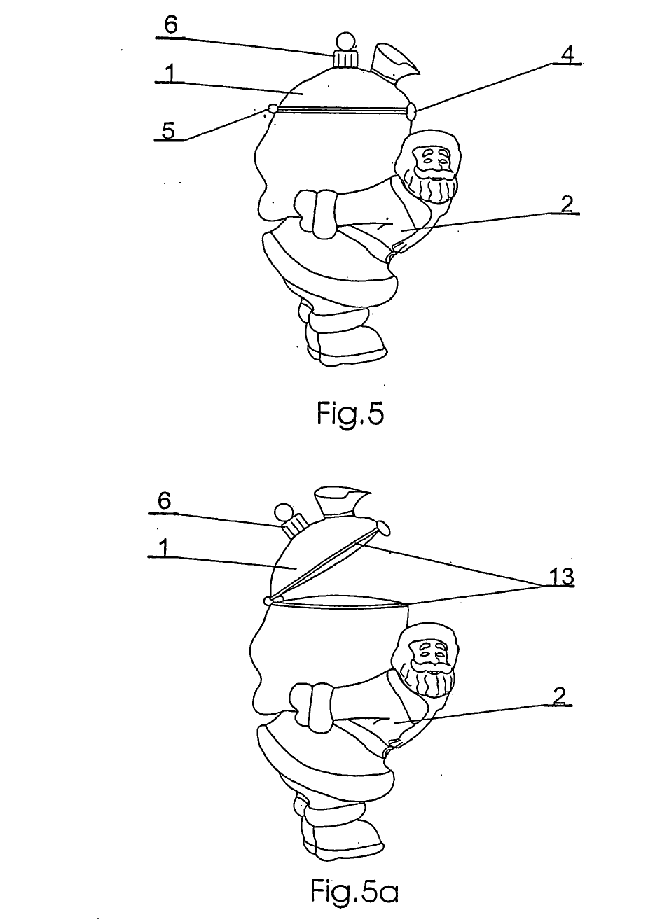

FIG. 5 illustrates an asymmetric ornament in a shape of Santa Claus carrying a bag with presents, the top of which is closed. An asymmetric bottom module 2 features Santa Claus with a bottom part of the bag with presents and the top module 1 features a top part of a bag that opens. The rims of both modules are provided with a metal band 13 in the connecting plane thereof. The metal band 13 is provided with a hinge 5 which enables bending aside of the top module and a lock 4 which enables closing of both modules. FIG. 5a illustrates an ornament in a shape of Santa Claus carrying a bag, the top module of which is bent aside by means of a hinge 5 after prior opening of a clip-lock 4; the rims of both modules are provided with a metal band 13 in the connecting plane thereof. The top fullering 6 can be closed or opened in order to affix a suspension means. The interior of an ornament can be freely filled.

### EXAMPLE VI

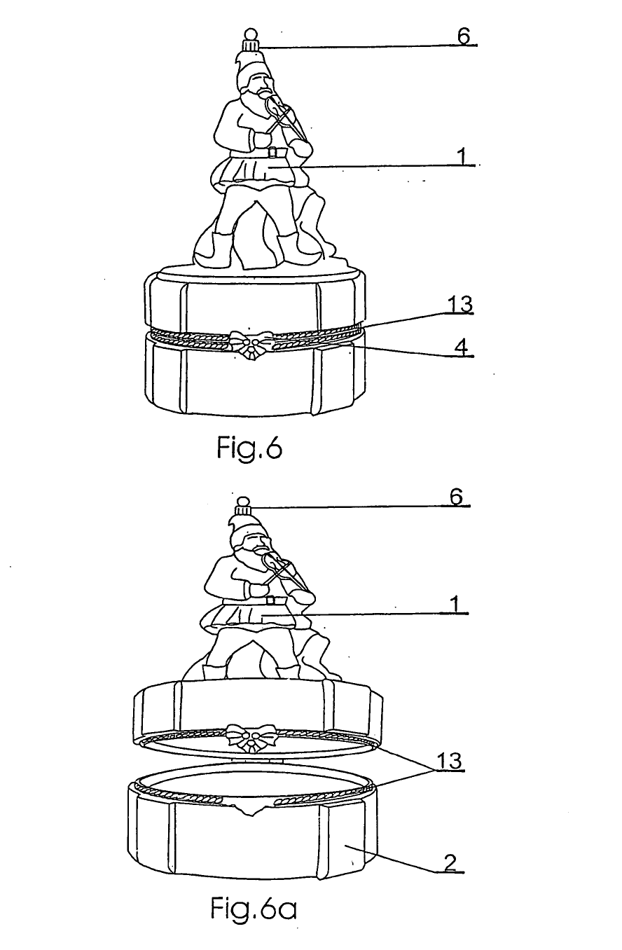

FIG. 6 illustrates a closed, symmetrical spatial body in a shape of a box with an asymmetrical object in a shape of a fiddler installed on a lid of a box. The lid of the box together with an asymmetrical object in a shape of a fiddler constitutes the top module 1 of a seasonal ornament; the bottom part of the box constitutes the bottom module 2 of a seasonal ornament. FIG. 6a illustrates the same open ornament, the top module 1 and the bottom module 2 of which are bent aside by means of a hinge 5 after prior opening of a clip-lock 4. The rims of both modules are provided with a metal band 13 in the connecting plane thereof. The top fullering 6 can be closed or opened in order to affix a suspension means.

### EXAMPLE VII

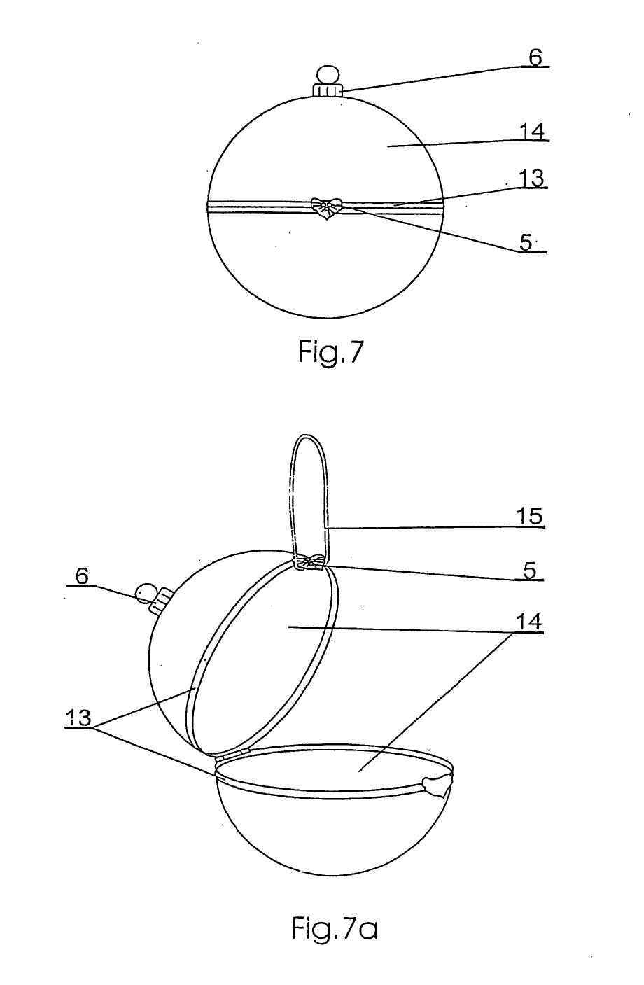

FIG. 7 illustrates a closed, symmetrical body made without using a mould and having a shape of a ball consisting of two parts which have smooth surface. It is provided with a metal hand 13 in the connecting plane thereof. The metal band 13 is provided with a hinge (not shown) and a lock 4. FIG. 7a illustrates the same open ornament. A lock 4 is provided with a string 15 and/or a lace for suspending an open ornament. The ball has hollow interior which can be freely filled.

The hereabove examples illustrate a range of technical solutions regarding the modules constituting particular forms of thin-walled glass ornaments as far as mouth blowing technology, the final treatment eg. installing metal bands in the connection plane of the modules, as well as the opening/closing means are concerned. The size of the modules constituting different ornaments may vary from small modules of symmetrical body to big asymmetric bodies connected with each other in order to obtain the final technical effect. The size and the shape of the particular modules which are connected with each other is not important. The hollow interior can be freely filled with various objects which can be contained in such interior.

What is claimed is:

1. A method for making a decorative ornament, said method comprising the steps of
mouth blowing a first thin-walled glass object;
cutting said first mouth blown thin walled glass object into first and second modules, where said first and second modules are dimensionally and spatially correlated, wherein the removal of said second module results in an a first module that forms said decorative ornament, said ornament having an opening therein corresponding to said removed second module.

2. The method as claimed in claim 1, wherein said step of mouth blowing said first thin walled glass object is performed in a mold.

3. The method as claimed in claim 1, wherein said step of mouth blowing said first thin walled glass object is performed without a mold.

4. The method as claimed in claim 1, further comprising the step of connecting or disconnecting said first module and said second module by means of at least two locks situated on the rim of each module.

5. The method as claimed in claim 1, further comprising the step of connecting said first and second modules by an articulated joint.

6. The method as claimed in claim 1, further comprising the step of dividing said first module into at least two spatial bodies where each spatial body is connected with said second module in the connection plane by an articulated joint and at least one lock;

7. The method as claimed in claim 6, further comprising the step of providing the first top module with a projection for affixing an additional item selected from the group consisting of lace, lace hanger, ornamental string, bow and wire.

8. The method as claimed in claim 1, further comprising the step of attaching a rim to edges of the first and second modules in the connection plane between them, and providing said rim with an articulated joint.

9. The method as claimed in claim 1, further comprising the step of providing the ornament with a projection for suspending a hanger.

10. The method as claimed in claim 1, further comprising the step of installing an object inside said ornament.

11. The method as claimed in claim 1, further comprising the step of providing a top part of said second bottom module with a flat surface of an inserted roof; and fastening at least one additional, miniature, ornamental object made of any material onto said inserted roof, or directly on the inner wall of said second module.

12. The method as claimed in claim 1, further comprising the step of covering an outer surface of said first module and said second module with ornament imprints obtained from a metal mould and the outer or inner surface of the ornament is then treated by any of the group consisting of paint, glitter, gold, silver and engraving.

13. The method as claimed in claim 1, further comprising the step of providing a lock for connecting both modules with a suspension string, wherein a smooth outer or inner surface of the ornament is then treated by any of the group consisting of glitter, gold, silver, and engraving.
